(19) United States
(12) Patent Application Publication
(10) Pub. No.: US 2011/0320527 A1
(43) Pub. Date: Dec. 29, 2011

(54) METHOD AND SYSTEM FOR MANAGING A WEB-DOMAIN REQUEST

(76) Inventor: Bhavin TURAKHIA, Mumbai (IN)

(21) Appl. No.: 12/856,845

(22) Filed: Aug. 16, 2010

(30) Foreign Application Priority Data
Jun. 29, 2010 (IN) 1887/MUM/20

(51) Int. Cl. G06F 15/16

(52) U.S. Cl. 709/203; 709/246

(57) ABSTRACT

A method and system for managing a request for a web-domain received from a client in a first format supported by a first service provider is disclosed. The method includes evaluating a plurality of conditions. The plurality of conditions include one or more of conditions such as a service provider of the web-domain is a second service provider, a Top Level Domain (TLD) of the request is supported by the second service provider and a request type of the request is one of an add request and a renew request. Subsequent to evaluating the plurality of conditions, a format of the request is transformed from the first format to a second format supported by a second service provider when one or more conditions of the plurality of conditions evaluate to true. Thereafter, the request is routed to the second service provider when one or more conditions of plurality of conditions evaluate to true and a request type of the request is a search request. Alternatively, the request is routed to the first service provider when each of the conditions of the plurality of conditions evaluates to false and a request type of the request is a search request.

### FIELD OF THE INVENTION

The invention generally relates to managing a request for a web-domain. More specifically, the invention relates to a method and system for routing a request for a web-domain to one or more service providers.

### BACKGROUND OF THE INVENTION

Generally a client sends requests to a reseller associated with a service provider for various web services such as, but not limited to, domain registration, web hosting and email hosted by the service provider. Examples of the requests may include, but not limited, an add request, a modify request, a delete request, a renew request, a read request and a search request. The reseller may provide a user interface (UI) for the clients to submit the requests. Usually, the UI provided by the reseller is configured to generate the requests in a format which is compliant with a format supported by the service provider. Accordingly, the reseller routes the requests to the service provider in the format supported by the service provider for processing the request.

In certain cases, it may be required for the reseller to migrate from a first service provider to a second service provider. However, such migration requires reconfiguring of the UI to generate requests in a format which is compliant with a format supported by the second service provider. Usually, reconfiguring of the UI is a cumbersome task which requires considerable amount of time and efforts from the reseller. Further, once reconfigured for the second service provider, the reseller may find it difficult to manage any request directed towards the first service provider. The above-mentioned problems cause hindrance to the reseller to simultaneously utilize services offered by one or more service providers.

Therefore, there is a need in the art for a method and system for managing a one or more requests for web-domains hosted by one or more service providers.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram showing an environment in which various embodiments of the invention may function.

FIG. 2 illustrates a method for managing a request for a web-domain in accordance with an embodiment of the invention.

FIG. 3 illustrates a method for managing a search request for a web domain in accordance with an embodiment of the invention.

FIG. 4 illustrates an exemplary process flow for managing a renew request for a web-domain received from a client in accordance with an exemplary embodiment of the invention

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to method and system for managing a request for a web-domain. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide a method and system for managing a request for a web-domain received from a client. The request is received in a first format supported by a first service provider. Thereafter, a plurality of conditions are evaluated. The plurality of conditions include one or more conditions such as a service provider for the web-domain is a second service provider, a Top-Level Domain (TLD) of the request is supported by the second service provider, a request type associated with the request is one of an add request and a renew request. Subsequent to the evaluation of the plurality of conditions, a format of the request is transformed from the first format to a second format supported by the second service provider when one or more conditions of the plurality of conditions evaluate to true. Thereafter, the request is routed to the second service provider when the one or more conditions evaluate to true. Alternatively, the request is routed to the first service provider when each of the conditions of the plurality of conditions evaluate to false. Additionally, the request is routed to the first service provider and the second service provider when the request type associated with the request is a search request.

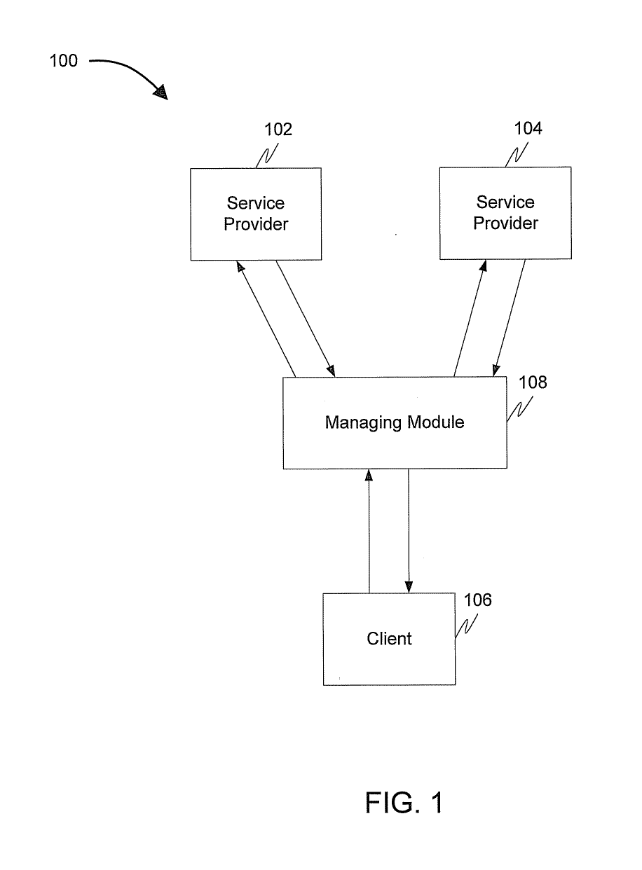

FIG. 1 illustrates a block diagram showing an environment 100 in which various embodiments of the invention may function. Environment 100 includes a service provider 102 and a service provider 104. A service provider provides one or more services associated with one or more web-domains. Examples of a service may include, but not limited to domain registration, web hosting, email hosting services and any service pertaining to management of the web-domain. A client 106 interacts with one or more of service provider 102 and service provider 104 for utilizing the one or more services for one or more web-domains. Client 106 sends one or more requests to one or more of service provider 102 and service provider 104 for availing the one or more services for the one or more web-domains. A service provider receives a request encoded in a format which is supported by the service provider. Examples of a format include, but not limited to, an XML based format, a JavaScript Object Notation (JSON) based format, a Comma-Separated Values (CSV) based format, a Structured Query Language (SQL) data based format and any other structured document based formats. In an exemplary embodiment, service provider 102 receives requests encoded in an Extensible Markup Language (XML) based format. Accordingly, all requests sent to service provider 102 are encoded in the XML based format. The one or more requests encoded in one or more formats are sent by client 106 using a managing module 108. In an embodiment, managing module 108 is Application Programming Interface (API) integrated with a user interface (UI) provided by a reseller to client 106 for submitting the requests. Managing module 108 interacts with service provider 102 and service provider 104 and routes the one or more requests received from client 106. Further, managing module 108 determines a format and a protocol based on which a request from client 106 is encoded in. Examples of a protocol include, but not limited to, Hypertext Transfer Protocol (HTTP), Remote Procedure Call (RPC) based protocol, Secure Shell (SSH) based protocol, Secure Socket Layer (SSL) based protocol, Transport Layer Security (TLS) based protocol, and Extensible Messaging and Presence Protocol (XMPP).

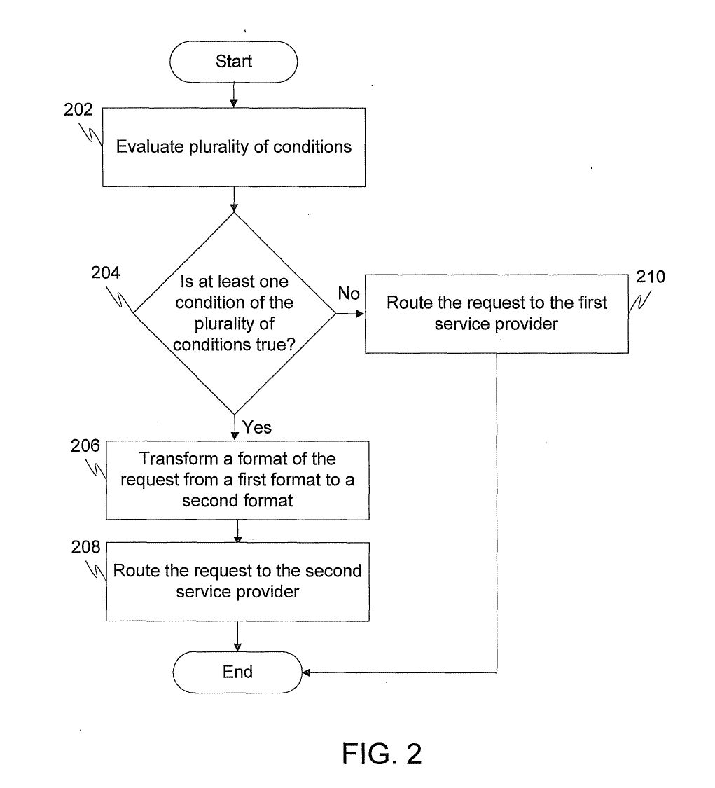

FIG. 2 illustrates a method for managing a request for a web-domain in accordance with an embodiment of the invention. A client may send the request for the web-domain in a first format supported by a first service provider. In an embodiment, the request sent by the client is logged in a request log. The request is associated with a request type. The request type may be, but not limited to, one of an add request, a search request and a renew request. For example, the request may be an add request corresponding to a new web-domain. In such a case, the request may have a Top-Level Domain (TLD) associated with the new web-domain. Based on the request it may be required to determine a service provider supporting the TLD associated with the new web-domain. Accordingly, at step 202, a plurality of conditions are evaluated. The plurality of conditions include conditions such as a service provider of a web-domain is a second service provider, a TLD of the request is supported by the second service provider, a request type of the request is one of an add request and a renew request. On evaluating the plurality of conditions, it is determined if one or more conditions of the plurality of conditions are true at step 204. When the plurality of conditions are true a format of the request is transformed from the first format to a second format supported by the second service provider at step 206. For example, when an add request in a first format supported by service provider 102 is received, a format of the add request is transformed to a second format supported by service provider 104. In this case, service provider 102 supports an Extensible Markup Language (XML) based format and service provider 104 supports a JavaScript Object Notation (JSON) based format. Accordingly, at step 206, the format of the request in XML based format is serialized and transformed to the JSON based format supported by service provider 104. Alternatively, it may be required to transform a protocol and a set of attributes of the request. For example, service provider 102 supports an attribute “webdomain=www.example.com” and service provider 104 supports an attribute “web-domain=www.example.com” in a request. In this case it is required to transform the attribute supported by service provider 102 to the attribute supported by service provider 104.

Accordingly, in order to transform a first protocol associated with the request to a second protocol corresponding to the second format, a first set of parameters and attributes associated with the request in the first format are modified to a second set of parameters and attributes corresponding to the second format. For example, service provider 102 may receive a request encoded in a Uniform Resource Locator (URL) as a GET method based request. Similarly, service provider 104 may receive a request as a POST method based request. A format of the request may be transformed from a first format supported by service provider 102 to a second format supported by service provider 104. In such a case, the request encoded as a GET method based request is changed to a POST method based request. Further, the first set of parameters and attributes in the request may be modified to the second set of parameters and attributes corresponding to the second format supported by service provider 104. In another instance, service provider 102 may support requests received as HTTP requests and service provider 104 may receive requests received as encrypted requests over SSL. In such a case, the HTTP requests corresponding to service provider 102 is transformed to requests encrypted and transmitted over SSL.

Further, client 106 may send a renew request for the web-domain maintained by service provider 102. In response to receiving the renew request, managing module 108 determines that the web-domain may be transferred to service provider 104. Accordingly, the condition, a request type of the request for a web-domain is a renew request and the service provider of the web-domain is the first service provider, evaluates to true and the request is routed to service provider 104. In order to initiate the routing of the request, the request type of the request is converted to a transfer request. For example, client 106 may send a renew request for a web-domain “www.example.com” maintained by service provider 102. In such a case, the request type of the request is converted to a transfer request. The transfer request corresponds to a request for transferring the web-domain “www.example.com” to service provider 104. Subsequent to the transforming of the request, at step 208, the request transformed to the second format is routed to the second service provider. Accordingly, the web-domain is transferred to service provider 104.

Considering another example, wherein a request is received from client 106 associated with service provider 102 for adding a new web-domain with a TLD as “.biz”. At step 204, it is determined that the TLD of the new web-domain is supported by service provider 104. Accordingly, a format of the add request is transformed to a second format supported by service provider 104. Subsequent to the transforming of the add request, at step 208, the add request transformed to the second format is routed to the second service provider.

In response to the routing of the request to the second service provider at step 208, a request_response is received from the second service provider. In an embodiment, the request_response may be in the second format supported by the second service provider. Accordingly, the format of the request_response is transformed to the first format before transmitting the request_response to a client. For example, client 106 may use a web based user interface (UI) to send an add request in a JSON based format for a web-domain maintained by service provider 102. In this case, the UI supports the JSON based format and service provider 104 supports an XML based format. Accordingly, a format of the add request is transformed to the XML based format supported by service provider 104. Subsequently, a request_response is received from service provider 104 in the XML based format. However, since the UI supports the JSON based format, the format of the request_response is transformed to the JSON based format supported by service provider 102. Thereafter, the request_response transmitted to client 106 using the UI. Further, the request_response from the second service provider is logged in a response log.

Alternately, if it is determined at step 204 that each of the conditions of the plurality of conditions evaluates to false, then at step 210 the request is routed to the first service provider. For example, a request received from client 106 for a web-domain associated with service provider 102 is a modify request for the web-domain. Based on evaluating the plurality of conditions, the modify request is routed to service provider 102.

In an embodiment, in response to the routing of the request to the first service provider at step 210, a request_response is received from the first service provider. For example, managing module 108 may route a request from client 106 to service provider 102 in the first format supported by service provider 102. Accordingly, a request_response is received from service provider 102 in the first format. Example of a request_response may include, but not limited to, a response indicating success of execution of a request, an error message and a corresponding error code, a request for information from a user sending the request and a status message corresponding to the request. The request_response may be received as a flat file from the first service provider. Thereafter, the request_response is transmitted to client 106 on the UI which is configured to receive a request_response in the first format. Further, the request_response is logged in a response log.

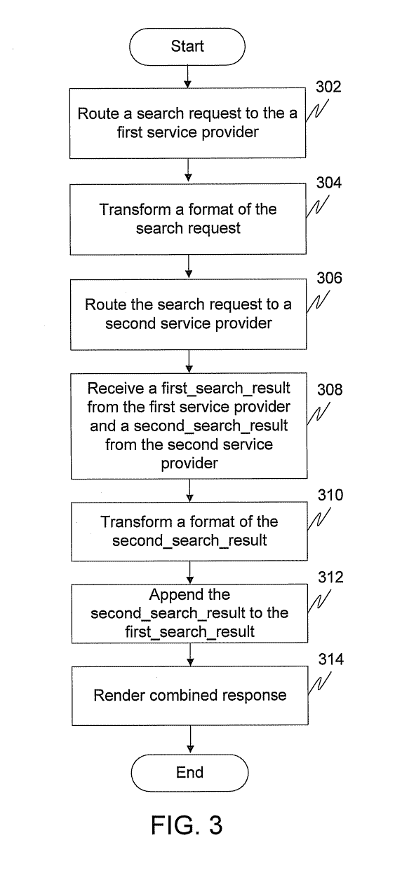

FIG. 3 illustrates a method for managing a search request for a web-domain in a first format supported by a first service provider in accordance with an embodiment of the invention. A client may initiate a search request in a form of a query to identify web-domains owned by the client that have a date of expiry within a specified duration of time. Accordingly, the search request is executed on the first service provider and the second service provider as the client may own multiple web-domains on the first service provider and the second service provider. In order to execute the query, the search request in the first format is routed to the first service provider at step 302. Additionally, the search request is also required to be routed to the second service provider. However, before routing the search request to the second service provider, a format of the search request is transformed to a second format supported by the second service provider at step 304. In an embodiment, transforming from the first format to the second format includes changing a first protocol associated with the first format of the search request to a second protocol associated with the second format supported by the second service provider. Additionally, a first set of parameters and attributes associated with the search request in the first format is modified to a second set of parameters and attributes corresponding to the second format.

Subsequent to transforming the format of the search request at step 304, the search request in the second format is routed to the second service provider at step 306. For example, service provider 102 may support search requests received in an XML based format and service provider 104 may support search requests received in a JSON based format. In such a case, a search request in the XML based format is transformed to the JSON based format and the search request in the XML based format is routed to service provider 102 and the search request in the JSON based format is routed to service provider 104.

In response to routing the search request to the first service provider and the second service provider, a first_search_result is received from the first service provider and a second_search_result is received from the second service provider at step 308. In an embodiment, search results obtained from the first service provider and the second service providers are in respective formats supported by the first service provider and the second service provider. For example, the first_search_result is in the XML based format and the second_search_result is in the JSON based format. Accordingly, the format of the second_search_result is transformed to the first format at step 310. For example, the format of the second_search_result is transformed to the XML based format. Thereafter, the second_search_result in the first format is appended to the first_search_result to form a combined response at step 312. In an embodiment, results in combined response are sorted based on a sorting preference provided by a client. For example, the results may be sorted based on a service provider of the one or more web-domains. Subsequently, the combined response is transmitted to the client at step 314.

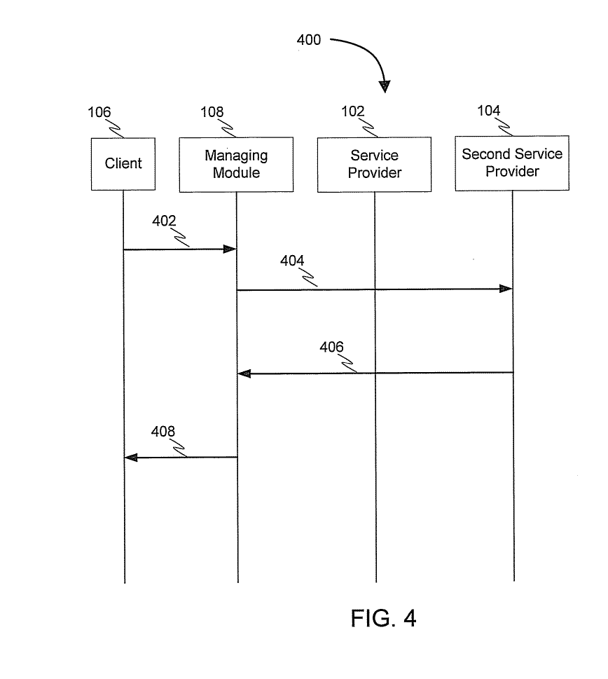

FIG. 4 illustrates an exemplary process flow 400 for managing a renew request for a web-domain received from a client in accordance with an exemplary embodiment of the invention. A reseller (not shown in FIG. 4) associated with service provider 102 provides various web services associated with one or more web-domains hosted by service provider 102. Accordingly, the reseller provides a user interface (UI) to one or more clients for submitting one or more requests for the one or more web-domains. The UI is configured to generate one or more requests in the first format supported by service provider 102. Further, based on evolving business requirements, the reseller may decide to subscribe to web services provided by service provider 104. In an instance, the reseller may migrate partially or completely from service provider 102 to service provider 104. Accordingly, the reseller is required to support one or more requests directed towards service provider 102 and service provider 104 by complying with first format and second format supported by the service provider 102 and service provider 104 respectively.

At step 402, client 106 sends a renew request in the first format supported by service provider 102 for a web-domain hosted by service provider 102 to the UI of the reseller. In accordance with the method and system of the invention, managing module 108 interacts with the UI to route a request received from client. Managing module is one of an extension tool to a browser used by client 106 to submit the renew request, and an Application Programming Interface (API) proxy for a web based application provided by the reseller.

Accordingly, based on the reseller's complete or partial migration from service provider 102 to service provider 104, managing module 108 determines an appropriate service provider for processing the request. In an instance, when it is decided to utilize web-services of service provider 104 for one or more web-domains, the renew request received from the client is routed to service provider 104. Accordingly, managing module 108 converts the renew request to a transfer request. Thereafter, managing module 108 transforms a format of the transfer request in the first format supported by service provider 102 to a second format supported by service provider 104. Subsequently, the transfer request in the second format is routed to service provider 104 at step 404. In order to complete the transfer process, service provider 104 transmits a transfer request to a registry (not shown in the fig). In an embodiment, the request for transferring the web-domain is sent as a HTTP request.

In response to receiving the transfer request the registry facilitates transfer of the web-domain from service provider 102 to service provider 104. Subsequent to the transfer of the web-domain, a request_response in the second format is transmitted by the service provider 104 to managing module 108 at step 406. Thereafter, managing module 108 converts the format of the request_response to the first format. The request_response in the first format is rendered to client 106 at step 408. In an embodiment, the request_response is rendered to client 106 on a web based user interface used by client 106 to send the renew request. In another embodiment, the request_response is rendered on the web based application used by a reseller to receive the renew request from client 106.

Various embodiments of the invention provide methods and systems for managing a request for a web-domain received from a client. The method and system enables a reseller to manage one or more web-domains hosted by one or more service providers. Further, the method and system facilitates the reseller to migrate between one or more service providers without performing modifications to a user interface provided by the reseller for submitting the requests to comply with formats of each of the one or more service providers.

The method for managing a request for a web-domain received from a client, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method of the invention.

The computing device executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the computing device to perform specific tasks such as the steps that constitute the method of the invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the computing device may be in response to user commands, or in response to results of previous processing or in response to a request made by another computing device.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for managing a request for a web-domain, the request being received from a client in a first format supported by a first service provider, the method comprising:
evaluating a plurality of conditions, wherein the plurality of conditions comprises at least one of:
a service provider of the web-domain is a second service provider;
a Top Level Domain (TLD) of the request is supported by the second service provider; and
a request type of the request is one of an add request and a renew request;
transforming a format of the request from the first format to a second format supported by the second service provider when at least one condition of the plurality of conditions evaluates to true;
routing the request to the second service provider when at least one of a at least one condition of the plurality of conditions evaluates to true and a request type of the request is a search request; and
routing the request to the first service provider when at least one of a request type of the request is a search request and each condition of the plurality of conditions evaluates to false.

2. The method of claim 1, wherein a request type of the request is at least one of an add request, a delete request, a modify request, a read request, a transfer request, a search request and a renewal request for the web-domain.

3. The method of claim 1, wherein the transforming comprises:
converting the request type of the request to a transfer request when the request type is a renewal request and the service provider of the web-domain is the first service provider.

4. The method of claim 1, wherein the transforming comprises performing at least one of:
changing a first protocol associated with the request to a second protocol corresponding to the second format; and
modifying a first set of parameters and attributes associated with the request in the first format to a second set of parameters and attributes corresponding to the second format.

5. The method of claim 1 further comprising:
receiving a request_response from the first services provider in response to routing the request to the first service provider; and
transmitting the request_response to the client.

6. The method of claim 5 wherein the request_response is maintained in a response log.

7. The method of claim 1 further comprising:
receiving a request_response from the second service provider in a second format in response to routing the request to the second service provider;
converting a format of the request_response from the second format to the first format; and
transmitting the request_response in the first format to the client.

8. The method of claim 7 wherein the request_response is maintained in a response log.

9. The method of claim 1, wherein the request is maintained in a request log.

10. The method of claim 1 further comprising receiving at least one of a first_search_result from the first service provider and a second_search_result from the second service provider in response to routing a search request to each of the first service provider and the second service provider.

11. The method of claim 10 further comprising:
transforming a format of the second_search_result to the first format;
appending the second_search_result to the first_search_result to form a combined response; and
transmitting the combined response to the client.

12. The method of claim 11, wherein appending further comprises sorting the combined response in an order as requested by the client

13. A computer program product residing on a computer readable medium for executing instructions on a processor, the computer program product being operable to cause the processor to perform a method for managing a request for a web-domain, the request being received from a client in a first format supported by a first service provider, the method comprising:
evaluating a plurality of conditions, wherein the plurality of conditions comprises at least one of:
a service provider of the web-domain is a second service provider;
a Top Level Domain (TLD) of the request is supported by the second service provider; and
a request type of the request is one of an add request and a renew request;
transforming a format of the request from the first format to a second format supported by the second service provider when at least one condition of the plurality of conditions evaluates to true;
routing the request to the second service provider when at least one of a at least one condition of the plurality of conditions evaluates to true and a request type of the request is a search request; and
routing the request to the first service provider when at least one of a request type of the request is a search request and each condition of the plurality of conditions evaluates to false.

14. The computer program product of claim 13, wherein the transforming comprises:
converting the request type of the request to a transfer request when the request type is a renewal request and the service provider of the web-domain is the first service provider.

15. The computer program product of claim 13, wherein the transforming comprises performing at least one of:
changing a first protocol associated with the request to a second protocol corresponding to the second format; and
modifying a first set of parameters and attributes associated with the request in the first format to a second set of parameters and attributes corresponding to the second format.

16. The computer program product of claim 13, wherein the method further comprises:
receiving a request_response from the first services provider in response to routing the request to the first service provider; and
rendering the request_response to the client.

17. The computer program product of claim 13, wherein the method further comprises:
receiving a request_response from the second service provider in a second format in response to routing the request to the second service provider;
converting a format of the request_response from the second format to the first format; and
transmitting the request_response in the first format to the client.

18. The computer program product of claim 13, wherein the method further comprises receiving at least one of a first_search_result from the first service provider and a second_search_result from the second service provider in response to routing a search request to each of the first service provider and the second service provider.

19. The computer program product of claim 18, wherein the method further comprises:
transforming a format of the second_search_result to the first format;
appending the second_search_result to the first_search_result to form a combined response; and
transmitting the combined response to the client.

20. The computer program product of claim 19, wherein the appending further comprises sorting the combined response in an order as requested by the client.
